(19) United States
(12) Patent Application Publication
(10) Pub. No.: US 2016/0163149 A1
(43) Pub. Date: Jun. 9, 2016

(54) ENHANCED GAMING MACHINE WITH THREE DIMENSIONAL GAME SPACE

(71) Applicant: GTECH CANADA ULC, Moncton (CA)

(72) Inventors: Reuben DUPUIS, Moncton (CA); Vicky LEBLANC, Moncton (CA)

(21) Appl. No.: 14/559,140

(22) Filed: Dec. 3, 2014

(51) Int. Cl. G07F 17/32; G07F 17/34

(52) U.S. Cl. CPC G07F 17/3213; G07F 17/34

(57) ABSTRACT

An electronic gaming machine that includes a three-dimensional (3D) graphics processor to generate a 3D supplemental game space for a game. A game matrix is displayed at an original position, where the game matrix includes game symbols. A display controller uses the 3D graphics processor to generate a 3D movement animation on a display device for moving the game matrix on an axis to a new position to render visible a 3D supplemental game space on the display device. The display controller generates another 3D movement animation of supplemental game symbols moving through the 3D supplemental game space onto the game matrix. A physical interaction between the supplemental game symbols and the game symbols of the game matrix results in a winning game outcome.

### FIELD

Embodiments described herein relate to the field of electronic gaming machines. The embodiments described herein particularly relate to the field of providing an enhanced gaming machine with three dimensional enhancements.

### INTRODUCTION

Various video gaming terminals or machines may consist of slot machines, online gaming systems (that enable users to play games using computer devices, whether desktop computers, laptops, tablet computers or smart phones), computer programs for use on a computer device (including desktop computer, laptops, tablet computers of smart phones), or gaming consoles that are connectable to a display such as a television or computer screen.

Video gaming machines may be configured to enable users to play a variety of different types of games. Example games may involve a matrix or grid of cells, where gaming symbols or elements may be displayed within the cells. One type of game displays a plurality of moving arrangements of gaming elements (such as reels, and symbols on reels) within a matrix. Another type of game displays gaming elements within a matrix in a fixed arrangement such as a keno or bingo type game. Another example game is checkers, and other board games. A further example is poker. Players may wager on gaming outcomes to win tangible awards. One or more winning combinations may be displayed using a pattern of gaming elements in an arrangement of cells (or an array) of the matrix, where each cell may include a gaming element, and where gaming elements may define winning combinations (or a winning pattern). Games that are based on winning patterns may be referred to as pattern games.

One example of a pattern game is a game that includes spinning reels, where a user wagers on one or more lines, activates the game, and the spinning reels are stopped to show one or more patterns in an array. The game rules may define one or more winning patterns of gaming elements, and these winning patterns may be associated with credits, points or the equivalent.

Another example type of game may be a Keno or Bingo type game where different gaming elements are activated that correspond to one or more gaming elements in the cells of the matrix, and the activated gaming elements may be used to define one or more winning combinations.

Gaming systems or machines are popular. However, there is a need to compete for the attention of users, and therefore it is necessary to innovate by launching new and engaging game machines.

### SUMMARY

In accordance with one aspect, there is provided an electronic gaming machine with at least one data storage device to store game data for a game. The electronic gaming machine has a three-dimensional graphics processor to generate a three-dimensional supplemental game space for the game in accordance with a set of game rules using the game data. The electronic gaming machine has an electronic display device to display, via a display interface, a game matrix on an x-axis and a y-axis at an original position, each cell of the game matrix having a game symbol. The electronic gaming machine has a display controller configured to, using the three-dimensional graphics processor, generate a pivot animation on the display device for pivoting the game matrix on an axis to a new position to render visible the three-dimensional supplemental game space on the display device. The display controller further generates a three-dimensional movement animation of one or more supplemental game symbols at a position along the z-axis and moving through the three-dimensional supplemental game space onto the game matrix. The display controller generates a physical interaction between the one or more supplemental game symbols and the one or more game symbols of the game matrix.

In accordance with some embodiments, the display controller is configured to, using the three-dimensional graphics processor, generate a complementary pivot animation on the display device for pivoting the game matrix on the axis from the new position to the original position.

In accordance with some embodiments, the three-dimensional movement animation includes a dropping animation of the one or more supplemental game symbols onto a cell of the game matrix.

In accordance with some embodiments, the three-dimensional movement animation comprises a fly out animation of the one or more supplemental game symbols to a cell of the game matrix.

In accordance with some embodiments, the three-dimensional movement animation is a dropping animation of the one or more supplemental game symbols onto a cell of an overlay grid relative to the game matrix, wherein the cell of the overlay grid overlays a plurality of cells of the game matrix.

In accordance with some embodiments, the electronic gaming machine has a game controller configured to: receive, via an input device, one or more wagers for one or more gaming outcomes, determine one or more gaming outcomes, wherein each gaming outcome comprises a combination of game symbols, determine that the one or gaming outcomes results in one or more winning game outcomes, and generate signals for distributing an award based on the one or more winning game outcomes.

In accordance with some embodiments, the physical interaction between the one or more supplemental game symbols and the one or more game symbols of the game matrix provides a winning game outcome of the one or more winning outcomes.

In accordance with some embodiments, the physical interaction between the one or more supplemental game symbols and the one or more game symbols of the game matrix provides a winning combination of game symbols, wherein a winning game outcome of the one or more winning outcomes is based on the winning combination of game symbols.

In accordance with some embodiments, the one or more game symbols of the game matrix provides a first winning combination, wherein the physical interaction between the one or more supplemental game symbols and the one or more game symbols of the game matrix provides a second winning combination.

In accordance with some embodiments, the pivot animation pivots the game matrix backward along a bottom edge so that the game matrix moves from an upright stance to a prone stance.

In another aspect, embodiments described herein may provide an electronic gaming machine with at least one data storage device to store game data for a game. The electronic gaming machine has a three-dimensional graphics processor to generate a three-dimensional supplemental game space for the game in accordance with a set of game rules using the game data. The electronic gaming machine may also have a display device to display, via a display interface, a two-dimensional game matrix at an original position, where each cell of the game matrix has a game symbol. The electronic gaming machine has a display controller configured to, using the three-dimensional graphics processor, generate a first three-dimensional movement animation on the display device for moving the two-dimensional game matrix to a new position to render visible the three-dimensional supplemental game space on the display device. The three-dimensional movement animation may be a pivot, shift back, shift forward, or other type of movement in a three-dimensional manner. The display controller may generate a second three-dimensional movement animation of one or more supplemental game symbols moving through the three-dimensional supplemental game space onto the game matrix. The display controller may generate a physical interaction between the one or more supplemental game symbols and the one or more game symbols of the game matrix.

In some embodiments, the display controller is configured to, using the three-dimensional graphics processor, generate a complementary pivot animation on the display device for pivoting the game matrix on the axis from the new position to the original position.

In some embodiments, the second three-dimensional movement animation comprises a dropping animation of the one or more supplemental game symbols onto a cell of the game matrix.

In some embodiments, the second three-dimensional movement animation comprises a fly out animation of the one or more supplemental game symbols to a cell of the game matrix.

In some embodiments, the second three-dimensional movement animation is a dropping animation of the one or more supplemental game symbols onto a cell of an overlay grid relative to the game matrix, wherein the cell of the overlay grid overlays a plurality of cells of the game matrix.

In some embodiments, the electronic gaming machine may have a game controller configured to: receive, via an input device, one or more wagers for one or more gaming outcomes, determine one or more gaming outcomes, wherein each gaming outcome comprises a combination of game symbols, determine that the one or gaming outcomes results in one or more winning game outcomes, and generate signals for distributing an award based on the one or more winning game outcomes.

In some embodiments, the physical interaction between the one or more supplemental game symbols and the one or more game symbols of the game matrix provides a winning game outcome of the one or more winning outcomes.

In some embodiments, the physical interaction between the one or more supplemental game symbols and the one or more game symbols of the game matrix provides a winning combination of game symbols, wherein a winning game outcome of the one or more winning outcomes is based on the winning combination of game symbols.

In some embodiments, the one or more game symbols of the game matrix provides a first winning combination, wherein the physical interaction between the one or more supplemental game symbols and the one or more game symbols of the game matrix provides a second winning combination.

In some embodiments, the first three-dimensional animation includes at least one of a pivot animation and a shift animation along a three-dimensional axis.

In another aspect, there is provided a method for an electronic gaming machine. The method may involve storing game data for a game using at least one data storage device;

displaying on a display device via a display interface, a game matrix on a x-axis and a y-axis at an original position, each cell of the game matrix comprising a game symbol; generating a pivot animation on the display device, using a display controller and the three-dimensional graphics processor, for pivoting the game matrix on a pivot axis to a new position to render visible a three-dimensional supplemental game space on the display device in accordance with a set of game rules using the game data; generating, at a position along the z-axis, a three-dimensional movement animation of one or more supplemental game symbols moving through the three-dimensional supplemental game space onto the game matrix; and generating a physical interaction between the one or more supplemental game symbols and the one or more game symbols of the game matrix to generate a winning combination and trigger distribution of a tangible award to a player.

In some embodiments, the method may further involve determining a winning game outcome based on the physical interaction between the one or more supplemental game symbols and the one or more game symbols of the game matrix, and triggering distribution of a tangible award based on the winning game outcome.

Many further features and combinations thereof concerning embodiments described herein will appear to those skilled in the art following a reading of the instant disclosure.

### DESCRIPTION OF THE FIGURES

FIG. 1 is a perspective view of an electronic gaming machine for implementing the gaming enhancements according to some embodiments;

FIG. 2a is a schematic diagram of an electronic gaming machine linked to a casino host system according to some embodiments;

FIG. 2b is a schematic diagram of an exemplary online implementation of a computer system and online gaming system according to some embodiments;

FIG. 2c is a schematic diagram of the computer system of FIG. 2b according to some embodiments;

FIG. 2d is a schematic diagram of an exemplary electronic gaming machine according to some embodiments;

FIG. 3 is a flowchart diagram of a method for a gaming machine according to some embodiments;

FIG. 4 is a schematic diagram of an example game matrix according to some embodiments;

FIG. 5 is a schematic diagram of an example three dimensional supplemental game space according to some embodiments;

FIG. 6 is a schematic diagram of an example supplemental game symbol at a position along the z-axis and moving through the three-dimensional supplemental game space onto the game matrix of FIG. 4 according to some embodiments;

FIG. 7 is a schematic diagram of multiple example supplemental game symbols at a position along the z-axis and moving through the three-dimensional supplemental game space onto the game matrix of FIG. 4 according to some embodiments;

FIG. 8 is a schematic of another example game matrix according to some embodiments;

FIG. 9 is a schematic diagram of another example supplemental game symbol at a position along the z-axis and moving through the three-dimensional supplemental game space onto the game matrix of FIG. 8 according to some embodiments; and

FIG. 10 is a schematic diagram of a further example supplemental game symbol at a position along the z-axis and moving through another example three-dimensional supplemental game space onto the game matrix of FIG. 4 according to some embodiments.

### DETAILED DESCRIPTION

Embodiments described herein relate to an enhanced electronic gaming machine (EGM) that includes a three-dimensional (3D) graphics processor configured to provide games with 3D enhanced game components. In particular, EGM is configured to generate a three-dimensional supplemental game space for a game in accordance with a set of game rules using game data stored in a data store. Example data stores are described herein. The electronic game machine displays a two-dimensional game matrix at an original position. Each cell of the game matrix comprising a game symbol. The game matrix may relate to a variety of game types, such as a reel-type game, keno-type game, bingo-type game, card-type game, board-type game and so on. The gaming machine may move the two-dimensional game matrix to provide the three-dimensional supplemental game space. The transition may be implemented using various animations to generate a larger game play virtual space for the player and provide a variety of different visual game play area presentations.

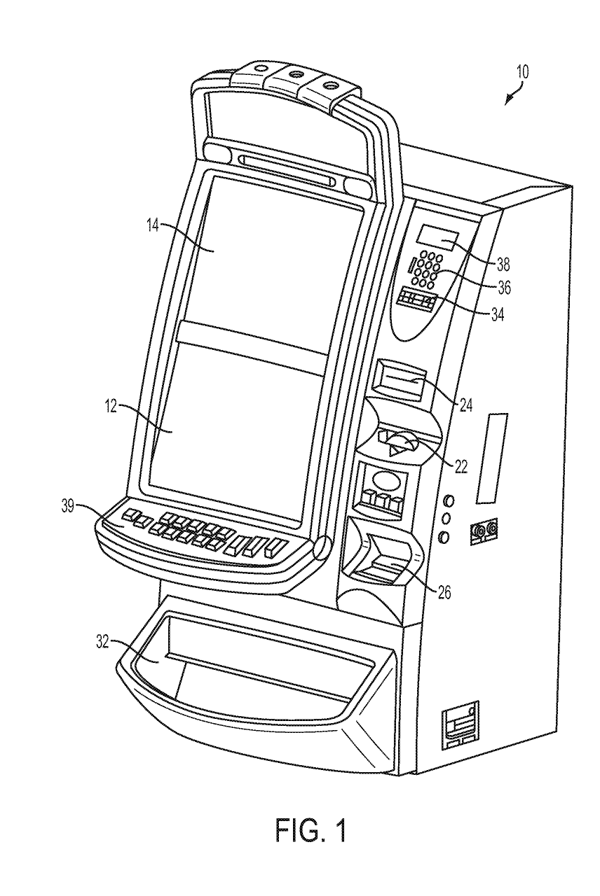

The gaming enhancements described herein may be carried out using a physical EGM. EGM may be embodied in a variety of forms and devices including, for example, portable devices, such as tablets and smart phones, that can access a gaming site or a portal (which may access a plurality of gaming sites) via the internet or other communication path (e.g., a LAN or WAN). The EGM may be located in various venues, such as a casino or an arcade. One example type of EGM is described with respect to FIG. 1.

FIG. 1 is a perspective view of an EGM 10 configured to provide 3D enhancements to game component. An example embodiment of EGM 10 includes a display 12 that may be a thin film transistor (TFT) display, a liquid crystal display (LCD), a cathode ray tube (CRT), auto stereoscopic 3D display and LED display, an OLED display, or any other type of display. An optional second display 14 provides game data or other information in addition to display 12. Display 14 may provide static information, such as an advertisement for the game, the rules of the game, pay tables, pay lines, or other information, or may even display the main game or a bonus game along with display 12. Alternatively, the area for display 14 may be a display glass for conveying information about the game. Display 12,14 may also include a camera, sensor, and other hardware input devices.

Display 12, 14 may have a touch screen lamination that includes a transparent grid of conductors. Touching the screen may change the capacitance between the conductors, and thereby the X-Y location of the touch may be determined. A processor of EGM 10 associates this X-Y location with a function to be performed. Such touch screens may be used for slot machines, for example, or other types of gaming machines. There may be an upper and lower multi-touch screen in accordance with some embodiments. One or both of display 12, 14 may be configured to have auto stereoscopic 3D functionality.

A coin slot 22 may accept coins or tokens in one or more denominations to generate credits within EGM 10 for playing games. An input slot 24 for an optical reader and printer receives machine readable printed tickets and outputs printed tickets for use in cashless gaming.

A coin tray 32 may receive coins or tokens from a hopper upon a win or upon the player cashing out. However, the EGM 10 may be a gaming terminal that does not pay in cash but only issues a printed ticket for cashing in elsewhere. Alternatively, a stored value card may be loaded with credits based on a win, or may enable the assignment of credits to an account associated with a computer system, which may be a computer network connected computer.

A card reader slot 34 may read from various types of cards, such as smart cards, magnetic strip cards, or other types of cards conveying machine readable information. The card reader reads the inserted card for player and credit information for cashless gaming. Card reader slot 34 may read a magnetic code on a conventional player tracking card, where the code uniquely identifies the player to a host system at the venue. The code is cross-referenced by the host system to any data related to the player, and such data may affect the games offered to the player by the gaming terminal. Card reader slot 34 may also include an optical reader and printer for reading and printing coded barcodes and other information on a paper ticket. A card may also include credentials that enable the host system to access one or more accounts associated with a user. The account may be debited based on wagers by a user and credited based on a win.

An electronic device may couple (by way of a wired or wireless connection) to the EGM 10 to transfer electronic data signals for player credits and the like. For example, near field communication (NFC) may be used to couple to EGM 10 which may be configured with NFC enabled hardware. This is a non-limiting example of a communication technique.

A keypad 36 may accept player input, such as a personal identification number (PIN) or any other player information. A display 38 above keypad 36 displays a menu for instructions and other information and provides visual feedback of the keys pressed.

Keypad 36 may be an input device such as a touchscreen, or dynamic digital button panel, in accordance with some embodiments.

Player control buttons 39 may include any buttons or other controllers needed to play the particular game or games offered by EGM 10 including, for example, a bet button, a repeat bet button, a spin reels (or play) button, a maximum bet button, a cash-out button, a display pay lines button, a display payout tables button, select icon buttons, and any other suitable button. Buttons 39 may be replaced by a touch screen with virtual buttons.

EGM 10 may also include a digital button panel. The digital button panel may include various elements such as for example, a touch display, animated buttons, frame lights, and so on. The digital button panel may have different states, such as for example, standard play containing bet steps, bonus with feature layouts, point of sale, and so on. The digital button panel may include a slider bar for adjusting the three-dimensional panel. The digital button panel may include buttons for adjusting sounds and effects. The digital button panel may include buttons for betting and selecting bonus games. The digital button panel may include a game status display. The digital button panel may include animation. The buttons of the digital button panel may include a number of different states, such as pressable but not activated, pressed and active, inactive (not pressable), certain response or information animation, and so on.

EGM 10 may also include hardware configured to provide motion or gesture tracking. For example, the EGM 10 may include a camera. The camera may be used for gesture or motion tracking of player, such as detecting player positions and movements, and generating signals defining x, y and z coordinates. For example, the camera may be used to implement tracking recognition techniques to collect tracking recognition data. An example type of motion tracking is optical motion tracking. The motion tracking may include a body and head controller. The motion tracking may also include an eye controller. EGM 10 may implement eye-tracking recognition technology using camera, sensors (e.g. optical sensor), data receivers and other electronic hardware to capture various forms of player input. A gesture or motion by a player may trigger provision of the 3D supplemental game space in some embodiments or may impact the type of movement or animation of the two-dimensional (2D) game matrix to reveal the 3D supplemental game space. Accordingly, EGM 10 may be configured to capture player gesture input and calculate an animation for movement of the 2D game matrix to reveal the 3D supplemental game space.

Embodiments described herein are implemented by physical computer hardware embodiments. The embodiments described herein provide useful physical machines and particularly configured computer hardware arrangements of computing devices, servers, electronic gaming terminals, processors, memory, networks, for example. The embodiments described herein, for example, is directed to computer apparatuses, and methods implemented by computers through the processing of electronic data signals.

Accordingly, EGM 10 is particularly configured to provide a 3D game space. The display screens 12, 14 may display, via a user interface, game components in accordance with a set of game rules using game data, stored in a data store.

A data capture device may capture player data, such as button input, gesture input and so on. The data capture device may include a camera, a sensor or other data capture electronic hardware.

Embodiments described herein involve computing devices, servers, electronic gaming terminals, receivers, transmitters, processors, memory, display, and networks particularly configured to implement various acts. The embodiments described herein are directed to electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, a various hardware components.

Substituting the computing devices, servers, electronic gaming terminals, receivers, transmitters, processors, memory, display, ports, and networks particularly configured to implement various acts for non-physical hardware, using mental steps for example, may substantially affect the way the embodiments work.

Such computer hardware limitations are clearly essential elements of the embodiments described herein, and they cannot be omitted or substituted for mental means without having a material effect on the operation and structure of the embodiments described herein. The computer hardware is essential to the embodiments described herein and is not merely used to perform steps expeditiously and in an efficient manner.

As described herein, EGM 10 may be configured to provide a 3D supplemental game space. The 3D supplemental game space may be an enhancement to a primary game or may be a new game that is independent of the primary game. The 3D supplemental game space may be provided dynamically and revealed by dynamic triggers from game content of the primary game in response to electronic data signals collected and processed by EGM 10.

The EGM 10 may include a display 12, 14 with auto stereoscopic three-dimensional functionality. The EGM 10 may include a touch screen display in some embodiments for receiving input data. The EGM 10 may also include a camera, for example. The EGM 10 may also include several effects and frame lights. The 3D enhancements may be 3D supplemental game space for additional game components or symbols.

EGM 10 may include an output device such as one or more speakers. The speakers may be located in various locations on the EGM 10 such as in a lower portion or upper portion. The EGM 10 may have a chair or seat portion and the speakers may be included in the seat portion to create a surround sound effect for the player. The seat portion may allow for easy upper body and head movement during play. Functions may be controllable via an on screen game menu. The EGM 10 is configurable to provide full control over all built-in functionality (lights, frame lights, sounds, and so on).

EGM 10 may also include a plurality of effects lights and frame lights. The lights may be synchronized with enhancements of the game. The EGM 10 may be configured to control color and brightness of lights. Additional custom animations (color cycle, blinking, etc.) may also be configured by EGM 10. The custom animations may be triggered by certain gaming events.

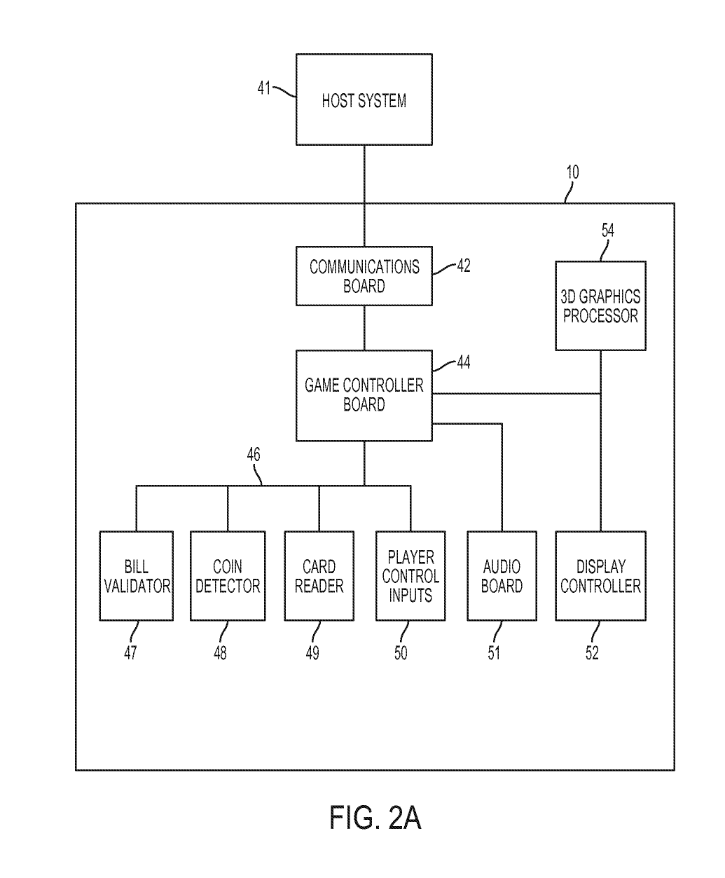

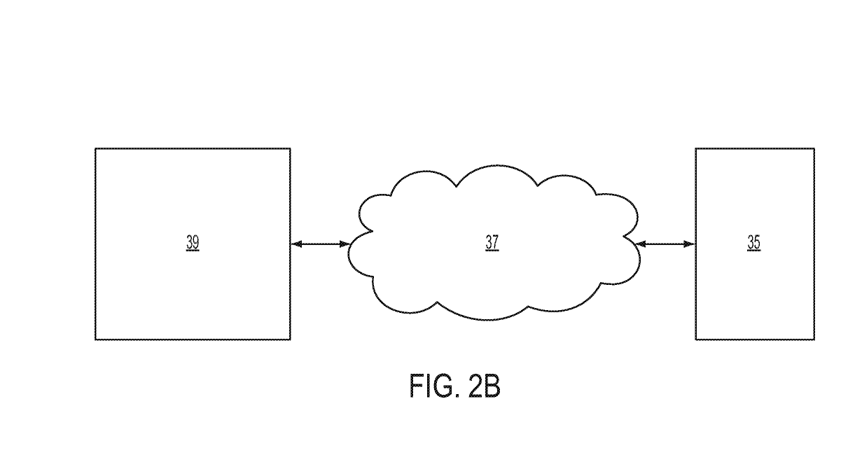

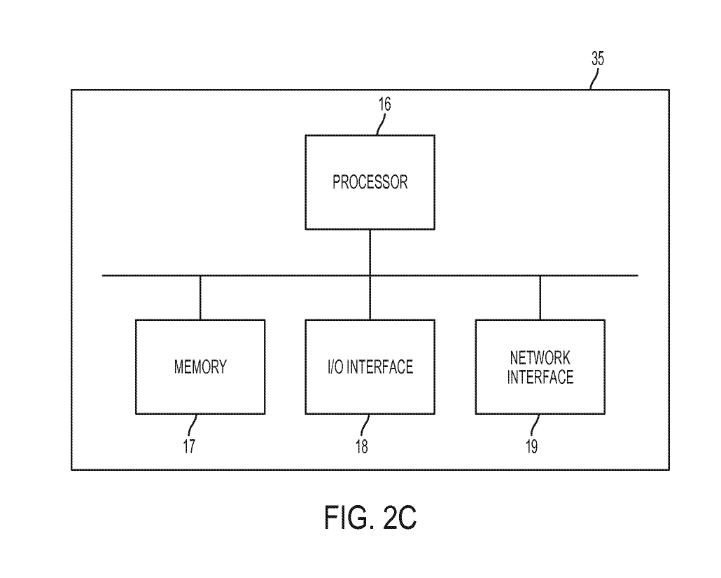

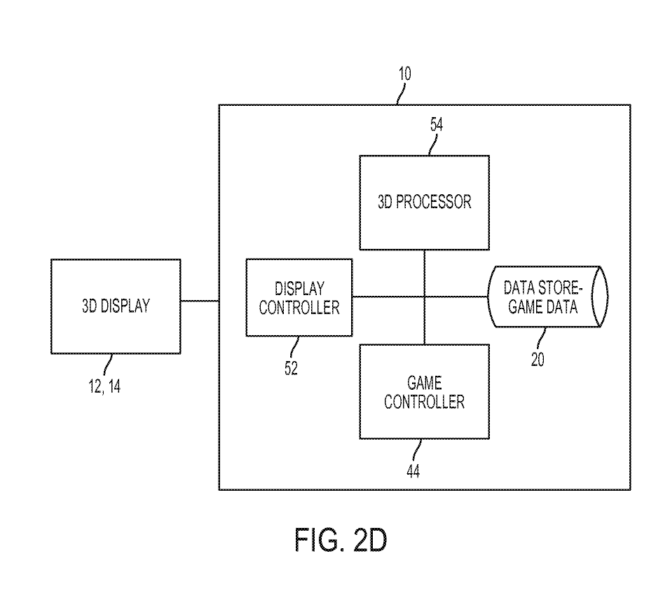

FIG. 2a is a block diagram of hardware components of EGM 10 according to some embodiments. EGM 10 is shown linked to the casino's host system 41 via network infrastructure. These hardware components particularly configured to provide games with 3D enhanced game components.

A communications board 42 may contain circuitry for coupling the EGM 10 to network. Communication board 42 may include a network interface allowing EGM 10 to communicate with other components, to access and connect to network resources, to serve an application, to access other applications, and to perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these. EGM 10 may communicate over a network using a suitable protocol, such as the G2S protocols.

Communications board 42 communicates, transmits and receives data using a wireless transmits, or it may be wired to a network, such as a local area network running throughout the casino floor, for example. Communications board 42 may set up a communication link with a master controller and may buffer data between the network and game controller board 44. Communications board 42 may also communicate with a network server, such as in accordance with the G2S standard, for exchanging information to carry out embodiments described herein.

Game controller board 44 includes memory and a processor for carrying out program instructions stored in the memory and for providing the information requested by the network. Game controller board 44 executes game routines using game data stores in a data store accessible to the game controller board 44, and cooperates with 3D graphics processor 54 and display controller 52 to provide games with 3D enhanced game components.

Peripheral devices/boards communicate with the game controller board 44 via a bus 46 using, for example, an RS-232 interface. Such peripherals may include a bill validator 47, a coin detector 48, a smart card reader or other type of credit card reader 49, and player control inputs 50 (such as buttons or a touch screen). Inputs 50 may include any of the buttons, touchscreen or gestures as described herein. Other peripherals may be one or more cameras used for collecting player input data, or other player movement or gesture data that may be used to trigger the display of the 3D supplemental game space.

Game controller board 44 may also control one or more devices that produce the game output including audio and video output associated with a particular game that is presented to the user. For example audio board 51 may convert coded signals into analog signals for driving speakers.

Game controller board 44 may be coupled to an electronic data store storing game data for one or more games. The game data may, for example, include a set of game rules for each of the one or more games. The electronic data store may reside in a data storage device, e.g., a hard disk drive, a solid state drive, or the like. Such a data storage device may be included in EGM 10, or may reside at host system 41. In some embodiments, the electronic data store storing game data may reside in the cloud.

Card reader 49 reads cards for player and credit information for cashless gaming. Card reader 49 may read a magnetic code on a conventional player tracking card, where the code uniquely identifies the player to a host system at the venue. The code is cross-referenced by host system 41 to any data related to the player, and such data may affect the games offered to the player by the gaming terminal. Card reader 49 may also include an optical reader and printer for reading and printing coded barcodes and other information on a paper ticket. A card may also include credentials that enable host system 41 to access one or more accounts associated with a user. The account may be debited based on wagers by a user and credited based on a win.

3D graphics processor 54 may be configured to generate and render 3D game enhancements for the supplemental game space based on one or more game rules as directed by game controller board 44. The 3D graphics processor 54 may be a specialized electronic circuit designed for 3D image processing in order to manipulate and transform data stored in memory to accelerate the creation of 3D images in a frame buffer for output to the display by way of display controller 52. The 3D graphics processor 54 may redraw various 3D game enhancements as they dynamically update. 3D graphics processor 54 may cooperate with game controller board and display controller 52 to generate and render 3D enhancements as described herein.

Display controller 52 may require a high data transfer rate and may convert coded signals to pixel signals for the display. Display controller 52 and audio board 51 may be directly connected to parallel ports on the game controller board 44. The electronics on the various boards may be combined onto a single board. Display controller 52 controls output to one or more displays 12, 14. Display controller cooperates with 3D graphics processor 54 to render 3D enhancements on display 12, 14.

Display controller 52 may be configured to interact with 3D graphics processor 54 to generate a pivot animation for pivoting the game matrix from its original to a new position to render visible the 3D supplemental game space on the display device. A pivot animation is an example and other movements of game matrix may reveal 3D supplemental game space.

Display controller 52 may generate a 3D movement animation of supplemental game symbols moving through the 3D supplemental game space onto the game matrix. Display controller 52 may generate a physical interaction between the supplemental game symbols and the game symbols of the game matrix that may result a winning gaming outcome and an enhanced game experience for the user.

Host system 41 may store account data for players. EGM 10 may communicate with host system 41 to update such account data, for example, based on wins and losses. In an embodiment, host system 41 stores the aforementioned game data, and EGM 10 may retrieve such game data from host system 41 during operation.

In some embodiments, the electronics on the various boards described herein may be combined onto a single board. Similarly, in some embodiments, the electronics on the various controllers and processors described herein may be integrated. For example, the processor of game controller board 44 and 3D graphics processor 54 may be a single integrated chip.

EGM 10 may be configured to provide 3D enhancements to one or more games playable at EGM 10. The enhancements may be enhancements to a primary game, or may be enhancements to a secondary or bonus game.

FIG. 2b illustrates an online implementation of a gaming system that provides 3D enhancements as described herein. The gaming system may be an online gaming device (which may be an example implementation of an EGM) in accordance with the 3D gaming enhancements. As depicted, the gaming system includes a server computer 35 and a gaming device 39 connected via network 37.

In some embodiments, gaming server 35 and gaming device 39 cooperate to implement the functionality of EGM 10, described above. So, aspects and technical features of EGM 10 may be implemented in part at gaming device 39, and in part at gaming server 35.

Gaming server 35 may be configured to enable online gaming, and may include game data and game logic to implement the games and enhancements disclosed herein. For example, gaming server 35 may include a player input engine configured to process player input and respond according to game rules. Gaming server 35 may include a graphics engine configured to generate 3D enhancements as disclosed herein. In some embodiments, gaming server may provide rendering instructions and graphics data to gaming device 39 so that graphics may be rendered at gaming device 39.

Gaming server 35 may also include a movement recognition engine that may be used to process and interpret collected player movement data, to transform the data into data defining manipulations of game components or view changes.

Network 37 may be any network (or multiple networks) capable of carrying data including the Internet, Ethernet, POTS line, PSTN, ISDN, DSL, coaxial cable, fiber optics, satellite, mobile, wireless (e.g. Wi-Fi, WiMAX), SS7 signaling network, fixed line, local area network, wide area network, and others, including any combination of these.

Gaming device 35 which may be particularly configured with hardware and software to interact with gaming server 39 via network 37 to implement gaming functionality and render 3D enhancements, as described herein. For simplicity only one gaming device 35 is shown but an electronic gaming system may include one or more gaming devices 35 operable by different players. Gaming device 35 may be implemented using one or more processors and one or more data stores configured with database(s) or file system(s), or using multiple devices or groups of storage devices distributed over a wide geographic area and connected via a network (which may be referred to as “cloud computing”). Aspects and technical features or EGM 10 may be implemented using gaming device 35.

Gaming device 35 may reside on any networked computing device, such as a personal computer, workstation, server, portable computer, mobile device, personal digital assistant, laptop, tablet, smart phone, an interactive television, video display terminals, gaming consoles, electronic reading device, and portable electronic devices or a combination of these.

Gaming device 35 may include any type of processor, such as, for example, any type of general-purpose microprocessor or microcontroller, a digital signal processing (DSP) processor, an integrated circuit, a field programmable gate array (FPGA), a reconfigurable processor, a programmable read-only memory (PROM), or any combination thereof. Gaming device 35 may include any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Gaming device 35 is operable to register and authenticate users (using a login, unique identifier, and password for example) prior to providing access to applications, a local network, network resources, other networks and network security devices. Computing device 30 may serve one user or multiple users.

Gaming device 35 may include one or more input devices, such as a keyboard, mouse, camera, touch screen and a microphone, and may also include one or more output devices such as a display screen (with 3D capabilities) and a speaker. Gaming device 35 has a network interface in order to communicate with other components, to access and connect to network resources, to serve an application and other applications, and perform other computing applications.

Gaming device 35 connected to gaming server 39 by way of network 37 to access technical 3D enhancements to games as described herein. Multiple gaming devices 35 may connect to gaming server 39, each gaming device 35 operated by a respective player.

FIG. 2C is a block diagram depicting hardware components of a gaming device 35, exemplary of an embodiment.

As depicted, gaming device 35 includes at least one processor 16, memory or data store 17, at least one I/O interface 18, and at least one network interface 19.

Processor 16 may be any type of processor, such as, for example, any type of general-purpose microprocessor or microcontroller, a DSP processor, an integrated circuit, an FPGA, a reconfigurable processor, a PROM, or any combination thereof. Processor 16 may also be a 3D graphics processor adapted to generate and render 3D graphics, as described above.

Memory 17 may be any type of electronic memory that is located either internally or externally such as, for example, RAM, ROM, CDROM, electro-optical memory, magneto-optical memory, EPROM, and EEPROM, FRAM or the like.

I/O interfaces 18 enables gaming device 35 to interconnect with input and output devices, e.g., peripheral devices or external storage devices. Such peripheral devices may include one or more input devices, such as a keyboard, mouse, camera, touch screen and a microphone, and may also include one or more output devices such as a display screen (with three dimensional capabilities) and a speaker.

Network interfaces 19 enables gaming device 35 to communicate with other networks, to access and connect to network resources, to serve an application, to access other applications, and perform other computing applications by connecting to a network such as network 37.

In an embodiment, gaming server 39 may include hardware components substantially similar to those shown in FIG. 2C.

In an embodiment, gaming device 35 and/or gaming server 39 may be implemented using multiple devices, multiple databases, or multiple storage devices distributed over a wide geographic area and connected via a network (which may be referred to as “cloud computing”). In an embodiment, EGM 10 and gaming server 39 may be integrated as a single system or a single device.

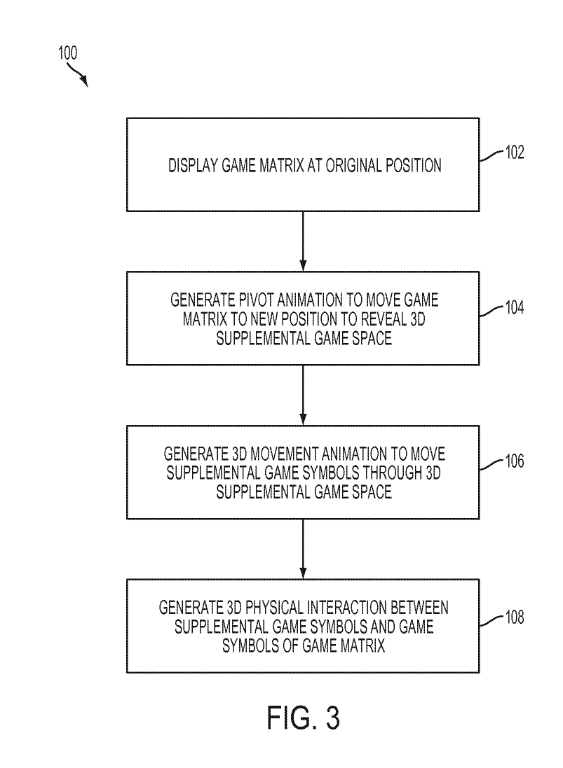

FIG. 3 is a flowchart of a method 100 implemented by EGM 10 for generating a 3D supplemental game space. For simplicity of illustration, method 100 will be described with reference to EGM 10 but it may be implement using gaming device 35, game server 39 or a combination thereof.

At 102, EGM 10 displays on a display device via a display interface, a game matrix on an x-axis and a y-axis at an original position, each cell of the game matrix comprising a game symbol.

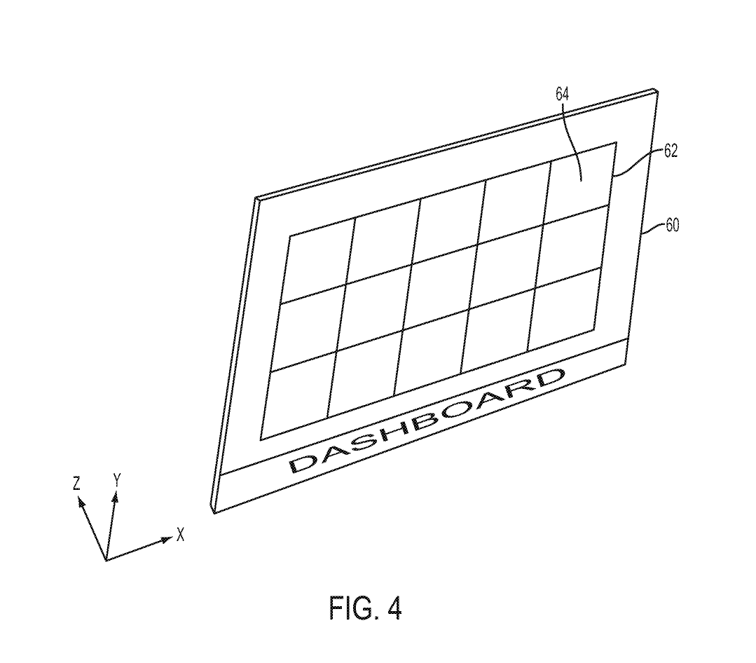

FIG. 4 is a schematic diagram of an example game matrix 62 according to some embodiments. The EGM 10 includes a display device 12, 14 to display, via a display interface 60, a game matrix 62. In this example, the game matrix 62 may be displayed on a plane defined by an x-axis and a y-axis at an original position. The x-axis and y-axis are shown relative to a z-axis to illustrate three dimensions.

In some embodiments, the main or primary game space provided by a game matrix 62 is designed to move or pivot in order to create the supplemental game space 70. The primary game space may have a default or original position. The examples may include an isometric view of the default positioning of the primary game space.

In some embodiments, one or more cells 64 of the game matrix 62 may contain a game symbol. For example, the game may be a reel-type game and a cell 64 of the game matrix 62 may include a game symbol that may be used to form winning combinations with other game symbols in other cells. As another example, the game may be a keno-type game and a cell 64 of the game matrix 62 may include keno number or other keno symbol. As a further example, the game may be a bingo-type game and a cell 64 of the game matrix 62 may include a bingo number or other bingo symbol. These are examples only and other games may also be implemented using the game matrix 62.

At 104 (FIG. 3), EGM 10 generates a pivot animation on the display device 12, 14 to pivot the game matrix to a new position to render visible a 3D supplemental game space in accordance with a set of game rules using stored game data. The set of game rules may define one or more events that trigger the pivot animation. For example, the pivot animation may result from a bonus event, specific combination of game symbols, a game symbol, and so on.

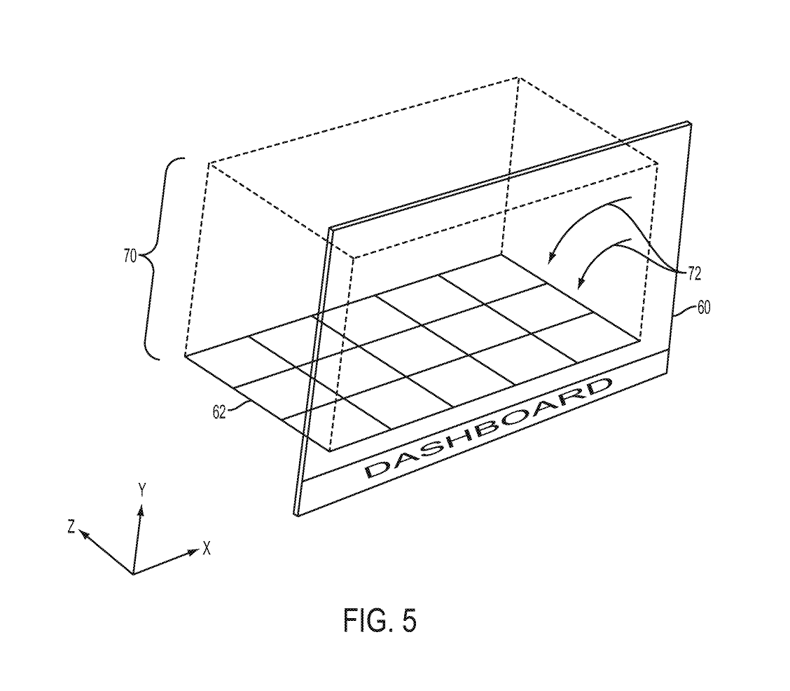

FIG. 5 is a schematic diagram of an example 3D supplemental game space 70 according to some embodiments. The EGM 10 generates a 3D pivot animation on the display interface 60 using the 3D graphics processor 54 and display controller 53. The pivot animation pivots the game matrix 62 to a new position to render visible the 3D supplemental game space 70 within the display interface 60. In this example, direction of movement of the game matrix 62 by the pivot animation is shown by arrows 72 along different positions on the z-axis. In this example the game matrix 62 may be displayed on a plane formed by an x-axis and a z-axis at the new position. The pivot animation pivots the game matrix 62 on the x-axis so that the game matrix moves through the space defined by the z-axis and the y-axis. The display interface 60 displays both the game matrix 62 and the 3D supplemental game space 70. In this example, the 3D supplemental game space 70 is a rectangular prism or cuboid. The 3D supplemental game space 70 may have different geometric shapes in other embodiments such as a cube, triangular prism, cone, pyramid, and so on.

The game matrix 62 space may pivot backwards along a bottom edge (e.g. x-axis edge) so that it moves from an upright stance to a prone stance. Animating this movement creates a virtual supplemental game space 70 that is a valid game play area. The game matrix 62 may pivot along another edge, or even reposition itself in a variety of configurations to create the supplemental game space. The original position may create a two dimensional game appearance and the supplemental game space may create a 3D game appearance.

At 106 (FIG. 3), EGM 10 generates a 3D movement animation of one or more supplemental game symbols moving through the 3D supplemental game space 70 onto the game matrix 62. The one or more supplemental game symbols may move starting at a position along the z-axis.

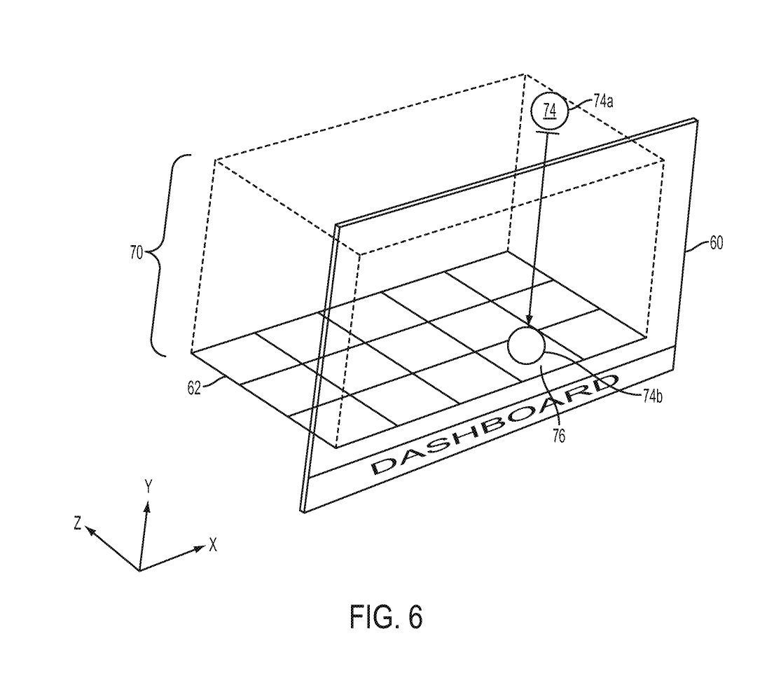

FIG. 6 is a schematic diagram of an example supplemental game symbol 74 at an initial position 74a along the z-axis and moving through the 3D supplemental game space 70 to an updated position 74b on the game matrix 62 according to some embodiments. The updated position 74b may overlap one or more cells of the game matrix 62. In this example, the update position overlaps one cell 76 of the game matrix 62.

When the game matrix 62 has been repositioned different enhancements may be provided by the 3D supplemental game space 70. The 3D supplemental game space 70 may provide a larger virtual game play area for gaming symbols. The supplemental game symbols 74 may move through the 3D supplemental game space 70 to interact with the game and trigger winning outcomes.

The supplemental game symbols 74 may be added into play at any depth or position along the z-axis. The other axes may also be used for positioning in other examples. Game play may continue within the 3D supplemental game space 70 with the game matrix 62 at its new updated position or the game matrix may move back to its original position through a complementary pivot or movement animation.

The 3D movement animation may be a dropping animation of the supplemental game symbol 74 onto a cell of an overlay grid relative to the game matrix 62. The cell of the overlay grid may overlay one or multiple cells of the game matrix.

At 108 (FIG. 3), EGM 10 generates a physical interaction between the one or more supplemental game symbols and the one or more game symbols of the game matrix. A physical interaction may be contact between the supplemental game symbol 74 and the cell 76 of the game matrix 62. The contact may result in a winning game outcome to provide a payout to a player. The player may be registered or anonymous. As shown, the 3D movement animation may include a dropping animation of the supplemental game symbols 74 onto a cell of the game matrix.

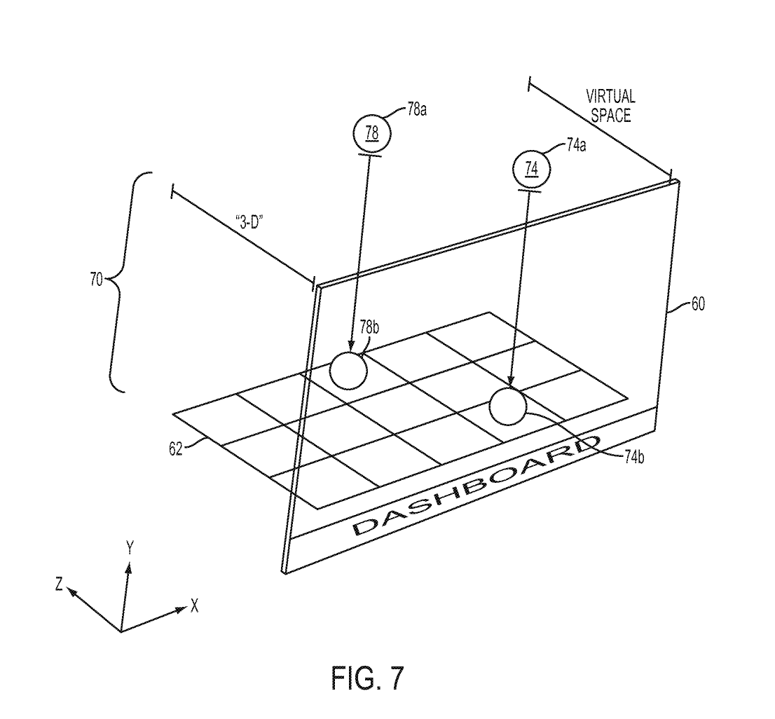

FIG. 7 is a schematic diagram of multiple example supplemental game symbols 74, 78. Each supplemental game symbol 74, 78 is shown at an initial position 74a, 78a along the z-axis and shown moving through the 3D supplemental game space 70 to an updated position 74b, 78b onto the game matrix 62 according to some embodiments. In this example, both supplemental game symbols 74, 78 may have a physical interaction with cells of the game matrix 62 to result in winning combinations.

Accordingly, the physical 3D processor 18 and the display controller 28 interact and exchange data to generate a 3D movement animation of the supplemental game symbols 74, 78. The supplemental game symbols 74, 78 move to various positions within the 3D supplemental game space 70 with an initial position along the z-axis and onto the game matrix 62 to generate a winning game outcome and trigger provision of a tangible award to a player.

The physical 3D processor 18 and the display controller 28 interact to generate a physical interaction between the supplemental game symbols 74, 78 and the game symbols within the cells of the game matrix 62.

The display controller 28 is configured to, using the 3D graphics processor 18, generate a complementary pivot animation on the display device 12, 14 for pivoting the game matrix 62 on the z-axis from the new position to the original position.

The game controller board 44 is configured to receive, via an input device, one or more wagers for gaming outcomes, and determine gaming outcomes. A gaming outcome is a combination of game symbols. The game controller board 44 is configured to determine that the gaming outcomes result in winning game outcomes, and generate signals for distributing a tangible award to a player based on the winning game outcomes.

In some embodiments, the physical interaction between the supplemental game symbols and the game symbols of the game matrix provides a winning game outcome.

In some embodiments, the physical interaction between the supplemental game symbols and the game symbols of the game matrix provides a winning combination of game symbols. The winning game outcome may be based on the winning combination of game symbols.

In some embodiments, the game symbols of the game matrix 62 provides a first winning combination, and the physical interaction between the supplemental game symbols and the game symbols of the game matrix provides an additional bonus winning combination.

In some embodiments, the pivot animation pivots the game matrix backward along a bottom edge so that the game matrix moves from an upright stance to a prone stance.

In this example, the supplemental 3D game space is generated by animations for moving and tilting the space on different axes through a 3D space created by three intersecting axes as shown. In some examples the tilt may be on the z-axis. Embodiments described herein provide a supplemental game space where special features may be presented to players in a clear manner. The technique efficiently uses the processing and memory resources to generate a 3D supplemental game space.

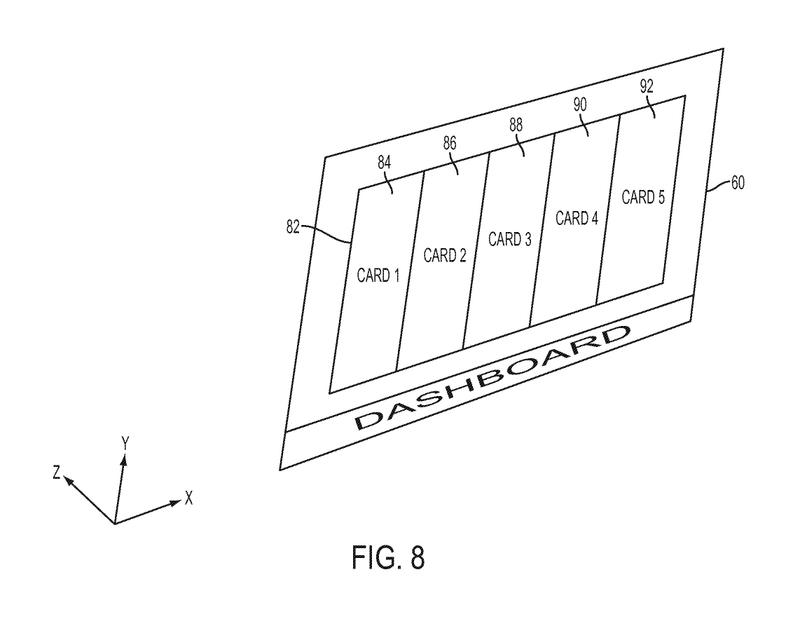

FIG. 8 is a schematic of another example game matrix 82 according to some embodiments. In this example, the game matrix 82 may represent cards 84, 86, 88, 90, 92 which may represent a card hand. For example, the cards 84, 86, 88, 90, 92 may relate to a game of poker. In this example, the game matrix 82 is an original position as a 2D game view or display.

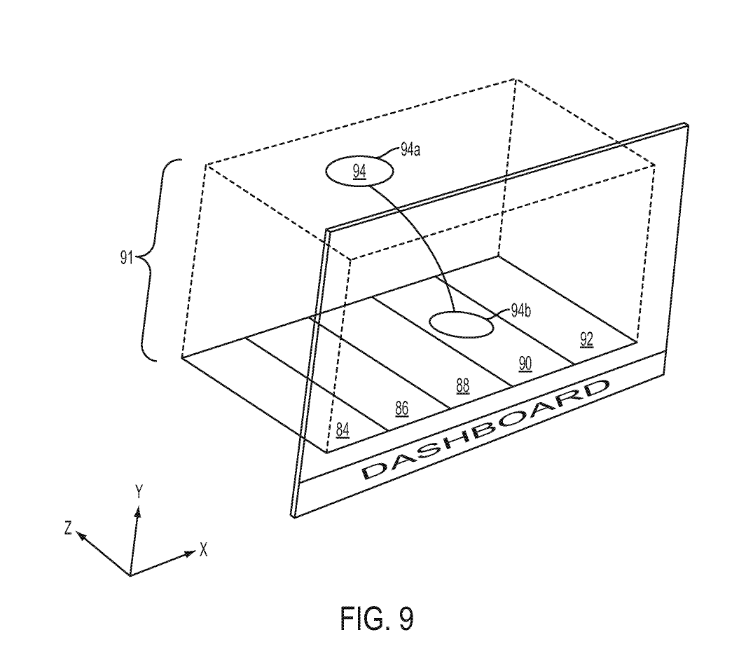

FIG. 9 is a schematic diagram of a pivot animation moving the game matrix 92 of cards 84, 86, 88, 90, 92 to a new position to provide a 3D supplemental game space 91. A supplemental game symbol 94 may appear at an initial position 94a along the z-axis and move through the 3D supplemental game space 91 onto the game matrix 92 to a new position 94b, as described herein. A physical interaction between the supplemental game symbol 94 and cards 84, 86, 88, 90, 92 may result in a winning outcome, such as a bonus, wild, multiple winning increase, and other enhancement to the regular card game.

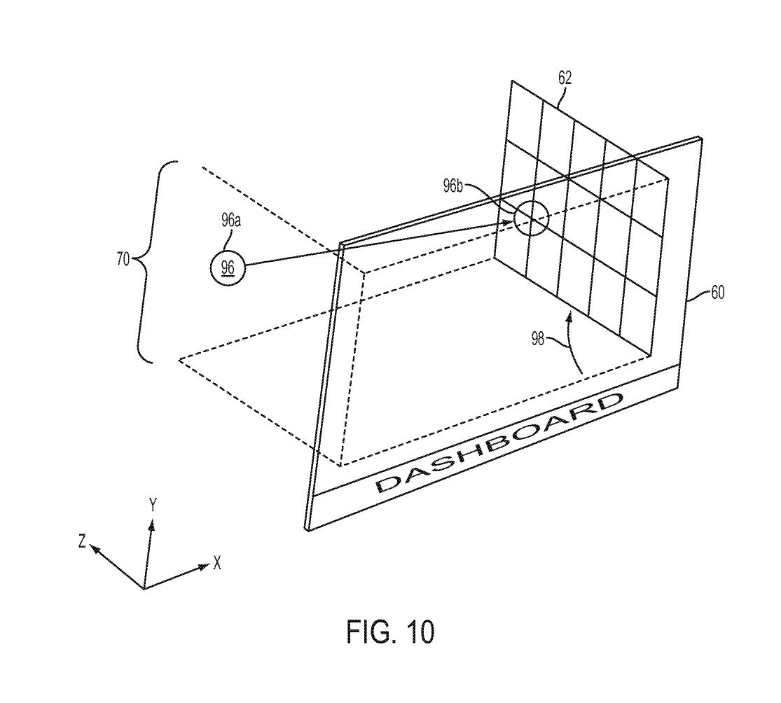

The pivot animation may pivot a game matrix 62 in a variety of ways on different axes. FIG. 10 is a schematic diagram of a further example pivot animation for a game matrix 62. In this example, the pivot animation pivots the game matrix 62 along the y-axis to a new position. A supplemental game symbol 96 at a depth or position along the z-axis moves through a 3D supplemental game space 70 onto the game matrix 62 in a new position 96b. As described, a physical interaction between the supplemental game symbol 96 and a game symbol of the game matrix 62 may result in a winning outcome and trigger distribution of a tangible award to a player operated EGM 10. In this example, a supplemental game symbol 96 is shown to fly out to a cell of an overlay grid relative to the game matrix 62. The cell of the overlay grid overlays multiple cells of the game matrix 62. For example, the supplemental game symbol 96 is shown to overlay four cells of the game matrix 62. The supplemental game symbol 96 may impact a winning combination involving one or more of the four overlapped cells to provide a winning outcome.

A pivot animation is an example movement animation that may reveal the 3D supplemental game space. Other examples include a shift back or shift forward of the game matrix 62 along the z-axis to reveal a 3D supplemental game space. Other movements may also be used to generate a 3D supplemental game space.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the following discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

One should appreciate that the systems and methods described herein may [note to draftsperson: consider describing example technical effects and solutions e.g. better memory usage, improved processing, improved bandwidth usage].

The following discussion provides many example embodiments. Although each embodiment represents a single combination of inventive elements, other examples may include all possible combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

Embodiments described herein may be implemented by using hardware only or by using software and a necessary universal hardware platform. Based on such understandings, the technical solution of embodiments may be in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided by the embodiments.

The embodiments described herein are implemented by physical computer hardware. The embodiments described herein provide useful physical machines and particularly configured computer hardware arrangements. The embodiments described herein are directed to electronic machines methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, a various hardware components. Substituting the computing devices, servers, receivers, transmitters, processors, memory, display, networks particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to the embodiments described herein and is not merely used to perform steps expeditiously and in an efficient manner.

For example, and without limitation, the computing device may be a server, network appliance, set-top box, embedded device, computer expansion module, personal computer, laptop, personal data assistant, cellular telephone, smartphone device, UMPC tablets, video display terminal, gaming console, electronic reading device, and wireless hypermedia device or any other computing device capable of being configured to carry out the methods described herein.

Although the embodiments have been described in detail, it should be understood that various changes, substitutions and alterations can be made herein without departing from the scope as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be exemplary only. The scope is indicated by the appended claims.

What is claimed is:

1. An electronic gaming machine comprising:
at least one data storage device to store game data for a game;
a three-dimensional graphics processor to generate a three-dimensional supplemental game space for the game in accordance with a set of game rules using the game data;
an electronic display device to display, via a display interface, a game matrix on a x-axis and a y-axis at an original position, each cell of the game matrix comprising a game symbol;
a display controller configured to using the three-dimensional graphics processor:
generate a pivot animation on the display device for pivoting the game matrix on an axis to a new position to render visible the three-dimensional supplemental game space on the display device;
generate a three-dimensional movement animation of one or more supplemental game symbols at a position along the z-axis and moving through the three-dimensional supplemental game space onto the game matrix; and
generate a physical interaction between the one or more supplemental game symbols and the one or more game symbols of the game matrix.

2. The electronic gaming machine of claim 1, wherein the display controller is configured to, using the three-dimensional graphics processor, generate an complementary pivot animation on the display device for pivoting the game matrix on the axis from the new position to the original position.

3. The electronic gaming machine of claim 1, wherein the three-dimensional movement animation comprises a dropping animation of the one or more supplemental game symbols onto a cell of the game matrix.

4. The electronic gaming machine of claim 1, wherein the three-dimensional movement animation comprises a fly out animation of the one or more supplemental game symbols to a cell of the game matrix.

5. The electronic gaming machine of claim 1, wherein the three-dimensional movement animation is a dropping animation of the one or more supplemental game symbols onto a cell of an overlay grid relative to the game matrix, wherein the cell of the overlay grid overlays a plurality of cells of the game matrix.

6. The electronic gaming machine of claim 1, further comprising a game controller configured to: receive, via an input device, one or more wagers for one or more gaming outcomes, determine one or more gaming outcomes, wherein each gaming outcome comprises a combination of game symbols, determine that the one or gaming outcomes results in one or more winning game outcomes, and generate signals for distributing an award based on the one or more winning game outcomes.

7. The electronic gaming machine of claim 5, wherein the physical interaction between the one or more supplemental game symbols and the one or more game symbols of the game matrix provides a winning game outcome of the one or more winning outcomes.

8. The electronic gaming machine of claim 1, wherein the physical interaction between the one or more supplemental game symbols and the one or more game symbols of the game matrix provides a winning combination of game symbols, wherein a winning game outcome of the one or more winning outcomes is based on the winning combination of game symbols.

9. The electronic gaming machine of claim 1, wherein the one or more game symbols of the game matrix provides a first winning combination, wherein the physical interaction between the one or more supplemental game symbols and the one or more game symbols of the game matrix provides a second winning combination.

10. The electronic gaming machine of claim 1, wherein the pivot animation pivots the game matrix backward along a bottom edge so that the game matrix moves from an upright stance to a prone stance.

11. An electronic gaming machine comprising:
at least one data storage device to store game data for a game;
a three-dimensional graphics processor to generate a three-dimensional supplemental game space for the game in accordance with a set of game rules using the game data;
a display device to display, via a display interface, a two-dimensional game matrix at an original position, each cell of the game matrix comprising a game symbol;
a display controller configured to, using the three-dimensional graphics processor:
generate a first three-dimensional movement animation on the display device for moving the two-dimensional game matrix to a new position to render visible the three-dimensional supplemental game space on the display device;
generate a second three-dimensional movement animation of one or more supplemental game symbols moving through the three-dimensional supplemental game space onto the game matrix; and
generate a physical interaction between the one or more supplemental game symbols and the one or more game symbols of the game matrix.

12. The electronic gaming machine of claim 1, wherein the display controller is configured to, using the three-dimensional graphics processor, generate an complementary pivot animation on the display device for pivoting the game matrix on the axis from the new position to the original position.

13. The electronic gaming machine of claim 10, wherein the second three-dimensional movement animation comprises a dropping animation of the one or more supplemental game symbols onto a cell of the game matrix.

14. The electronic gaming machine of claim 10, wherein the second three-dimensional movement animation comprises a fly out animation of the one or more supplemental game symbols to a cell of the game matrix.

15. The electronic gaming machine of claim 10, wherein the second three-dimensional movement animation is a dropping animation of the one or more supplemental game symbols onto a cell of an overlay grid relative to the game matrix, wherein the cell of the overlay grid overlays a plurality of cells of the game matrix.

16. The electronic gaming machine of claim 10, further comprising a game controller configured to: receive, via an input device, one or more wagers for one or more gaming outcomes, determine one or more gaming outcomes, wherein each gaming outcome comprises a combination of game symbols, determine that the one or gaming outcomes results in one or more winning game outcomes, and generate signals for distributing an award based on the one or more winning game outcomes.

17. The electronic gaming machine of claim 15, wherein the physical interaction between the one or more supplemental game symbols and the one or more game symbols of the game matrix provides a winning game outcome of the one or more winning outcomes.

18. The electronic gaming machine of claim 10, wherein the physical interaction between the one or more supplemental game symbols and the one or more game symbols of the game matrix provides a winning combination of game symbols, wherein a winning game outcome of the one or more winning outcomes is based on the winning combination of game symbols.

19. The electronic gaming machine of claim 10, wherein the one or more game symbols of the game matrix provides a first winning combination, wherein the physical interaction between the one or more supplemental game symbols and the one or more game symbols of the game matrix provides a second winning combination.

20. The electronic gaming machine of claim 10, wherein the first three-dimensional animation includes a pivot animation through the three-dimensional supplemental game space.

21. The electronic gaming machine of claim 10, wherein the first three-dimensional animation includes at least one of a shift animation back along a three-dimensional axis and a shift animation forward along a three-dimensional axis.
